(19) United States
(12) Patent Application Publication
(10) Pub. No.: US 2025/0002810 A1
(43) Pub. Date: Jan. 2, 2025

(54) SURFACE-ACTIVE AGENT

(71) Applicant: Econic Technologies Ltd, Macclesfield, Cheshire (GB)

(72) Inventors: Michael KEMBER, Macclesfield, Cheshire (GB); Anthea BLACKBURN, Macclesfield, Cheshire (GB); Charlotte WILLIAMS, Macclesfield, Cheshire (GB)

(21) Appl. No.: 18/701,535

(22) PCT Filed: Oct. 24, 2022
(86) PCT No.: PCT/EP2022/079614

§ 371 Date: Apr. 15, 2024

(30) Foreign Application Priority Data
Oct. 25, 2021 (GB) 2115335.8

(51) Int. Cl. C11D 1/72

(52) U.S. Cl. CPC C11D 1/72

(57) ABSTRACT

The invention concerns a surface-active agent comprising a polycarbonate block polyether of the formula I

Z¹—(PC)_{P}—(PE)_{Q}-Z² (I)
wherein PC represents a carbonate block with P repeat units of formula

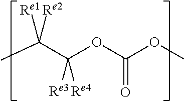

wherein R^{e1}, R^{e2}, R^{e3}, and R^{e4} are independently selected from H, methyl, ethyl, propyl, butyl, or an ether, ester or carbonate group, with the proviso that when one of R^{e1}, R^{e2}, R^{e3}, and R^{e4} is methyl, ethyl, propyl, butyl, or an ether, ester or carbonate group, the remaining R^{e1}, R^{e2}, R^{e3}, and R^{e4} are H;
PE represents a polyether block with Q repeat units of formula

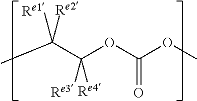

wherein R^{e1′}, R^{e2′}, R^{e3′}, and R^{e4′} are independently selected from H, methyl, ethyl, propyl, butyl, or an ether, ester or carbonate groups, with the proviso that when one of R^{e1}, R^{e2}, R^{e3}, and R^{e4} is methyl, ethyl, propyl, butyl, or an ether, ester or carbonate group, the remaining R^{e1′}, R^{e2′}, R^{e3′}, and R^{e4′} are H;
Z¹ is R, R—O, R—C(O)—O— or R—O—C(O)—O;
R is an optionally substituted straight or branched chain C₁-C₁₁ alkyl group;
Z² is H, R, R—(O)C or R—O—(O)C; and
wherein the value of P does not exceed the value of Q.

### FIELD

The present invention relates to surface-active agents, to catalysts and processes for making them, and to certain applications.

### BACKGROUND

Non-ionic surfactants are typically produced using a mono-ol starter having a large hydrophobic block. Examples include palm oil alcohols which provide the hydrophobic block. Palm oil usage has led to deforestation of other plant species and a corresponding reduction in the natural habitat for a number of endangered species. As a consequence, replacements for palm oil alcohols and the like (C₁₂-C₂₀ alcohols) are being sought.

Surface-active agents combining polyether and polycarbonate blocks are known in the art of oil extraction. WO2010/062703 and WO2015/031348 describe polymer compositions and supercritical CO₂ solutions of a potentially wide range of such polymers to assist with oil extraction. Such solutions form an emulsion waste product with water to assist with the oil extraction. There is no indication of any solubility in water or the use of such a water soluble polymer. The polymer compositions are designed to dissolve in liquid or supercritical CO₂ applications. WO2010/062703 mentions examples with a polyether block and a polycarbonate block but such is not exemplified, and the blocks are not fully characterised or tested.

WO2015/031348 describes polycarbonate blocks of the type:

Y—O-APC—O—CₓH_{y}

wherein APC is a polycarbonate and CₓH_{y} is a saturated or unsaturated hydrocarbon. The terminal group Y can be H or several other groups such as a polyether chain, but the latter is not exemplified or further identified.

US2021309801A1 discloses degradable ethylene oxide-based copolymers manufactured via boron-activated copolymerization of ethylene oxide monomers with carbon dioxide and their use as surfactants. Certain tri-block amphiphilic compounds are reported.

It would be beneficial to replace current aqueous non-ionic surfactants that use high hydrocarbyl alcohol derivatives as the hydrophobic section, either form fossil fuel or plant-based sources (such as palm oil) with lower hydrocarbyl sources which are cheaper and more readily available and potentially produced from bio sources such as bioethanol or butanol.

Surprisingly, the inventors have found that by altering the relative structure of the polycarbonate block polyether backbone lower hydrocarbyl alcohols can be utilised along with a polycarbonate section to form the hydrophobic group, providing a water-based surfactant without the need for higher hydrocarbyl alcohol derivatives.

### SUMMARY

According to a first aspect of the present invention there is provided a surface-active agent comprising a polycarbonate block polyether of the formula I

Z¹—(PC)_{P}—(PE)_{Q}-Z² (I)
wherein PC represents a carbonate block with P repeat units of formula

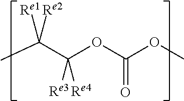

wherein R^{e1}, R^{e2}, R^{e3}, and R^{e4} are independently selected from H, methyl, ethyl, propyl, butyl, or an ether, ester or carbonate group, with the proviso that when one of R^{e1}, R^{e2}, R^{e3}, and R^{e4} is methyl, ethyl, propyl, butyl, or an ether, ester or carbonate group, the remaining R^{e1}, R^{e2}, R^{e3}, and R^{e4} are H;
PE represents a polyether block with Q repeat units of formula

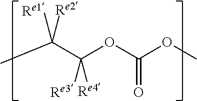

wherein R^{e1′}, R^{e2′}, R^{e3′}, and R^{e4′} are independently selected from H, methyl, ethyl, propyl, butyl, or an ether, ester or carbonate groups, with the proviso that when one of R^{e1}, R^{e2}, R^{e3}, and R^{e4} is methyl, ethyl, propyl, butyl, or an ether, ester or carbonate group, the remaining R^{e1′}, R^{e2′}, R^{e3′}, and R^{e4′} are H;
Z¹ is R, R—O, R—C(O)—O or R—O—C(O)—O;
R is an optionally substituted straight or branched chain C₁-C₁₁ alkyl group;
Z² is H, R, R—(O)C or R—O—(O)C; and
wherein the value of P does not exceed the value of Q.

Preferably Z¹ is R—C(O)—O or R—O—C(O)—O. Preferably Z¹ is a short (e.g. C₂-C₅ or C₂-C₄) chain carbonate or ester group.

preferably Z² is H or methyl, most preferably, Z² is H.

In the present invention the polycarbonate block acts as the hydrophobe and the polyether block acts as the hydrophile. As a consequence, when producing a surface-active agent according to the first aspect of the invention, the starter molecule does not need to be a large hydrocarbon chain such as that found in palm oil alcohols and other long chain alcohols and can instead be short chain alcohols or other starters, which are used to initiate synthesis of the polycarbonate block with a carbonate catalyst, prior to synthesis of a polyether block with an ether catalyst. Lower alcohol starters are also less expensive and more likely to be environmentally sustainable. Alternatively, the unique combination of the polyether block having the same number or more repeat units than the polycarbonate block that can be used and solubilised in a water-based surfactant composition allows production via a mono-hydroxyl functional polyether that can be used as an initiator for synthesis of a polycarbonate block with a carbonate catalyst, creating a polycarbonate block polyether via an alternative route, with no need for a long or short chain alcohol starter. If this method is used for production, it is preferable to end-cap the polycarbonate block, for example via reaction with an anhydride, to provide stability towards basic conditions and prevent degradation of the polycarbonate block. Surprisingly, it has been found that use of a suitably balanced hydrophobic polycarbonate and hydrophilic polyether block provides an alternative surfactant with much greater flexibility in design that is not dependent on environmentally damaging higher alcohols. This allows surfactants to be produced with smaller terminal hydrocarbyl groups.

There is also provided a process for producing a surface-active agent according to the first aspect of the invention the method comprising the steps of (i) reacting carbon dioxide and an epoxide in the presence of a carbonate catalyst, and a monofunctional starter compound to form a polycarbonate compound and (ii) reaction of the polycarbonate compound of step (i) with an epoxide and an ether catalyst to produce the surface-active agent according to the first aspect of the invention.

There is also provided a process for producing a surface-active agent according to the first aspect of the invention in a multiple reactor system; the system comprising a first and second reactor wherein a first reaction takes place in the first reactor and a second reaction takes place in the second reactor; wherein the first reaction is the reaction of a carbonate catalyst with CO₂ and epoxide, in the presence of a monofunctional starter compound, and optionally a solvent, to produce a polycarbonate compound and the second reaction is the semi-batch or continuous reaction of an ether catalyst with the polycarbonate compound of the first reaction and epoxide to produce the surface-active agent according to the first aspect of the invention.

Also provided in accordance with the invention is the use of the aforesaid surface-active agents: as agrichemical adjuvants; for the preparation of foams, coatings, paints, adhesives and sealants for the building construction industry; in the automotive industry; in the manufacture of textiles; for the enhanced recovery of crude oil

### DESCRIPTION OF EMBODIMENTS

Preferably the surface-active agent has greater than 10 wt % CO₂ incorporation, more typically, greater than 15, 20 or 21 wt % CO₂ incorporation. Preferably the surface-active agent has 10 to 40 wt % CO₂ incorporation, typically, 15 to 40 wt % CO₂ incorporation, more typically, 20 to 40 wt % CO₂ incorporation.

The epoxide in both the polycarbonate and polyether sections is independently selected from ethylene oxide (EO), propylene oxide (PO), butylene oxide, pentylene oxide, hexylene oxide, glycidyl ethers, glycidyl esters or glycidyl carbonates, or a mixture of two or more thereof. Preferably in the polycarbonate block the epoxide is ethylene oxide, propylene oxide, butylene oxide or a mixture thereof, preferably ethylene oxide or propylene oxide. Preferably in the polyether block the epoxide is ethylene oxide or propylene oxide or a mixture thereof, preferably ethylene oxide or propylene oxide, typically ethylene oxide.

It will also be appreciated that when a mixture of epoxides is used the epoxides will typically be statistically distributed along the polymer backbone.

Thus, when a mixture of epoxides is used the polycarbonate and the polyether blocks respectively may be referred to as a random copolymer or a statistical copolymer.

The identity of R^{e1}, R^{e2}, R^{e3}, R^{e4}, R^{e1′}, R^{e2′}, R^{e3′}, and R^{e4′} will depend on the nature of the epoxide used to prepare the polycarbonate or polyether. However, when one of R^{e1} to R^{e4} or one of R^{e1′} to R^{e2′} is methyl, ethyl, propyl, butyl, or an ether, ester or carbonate group the remaining three groups are H. Preferably R^{e1}, R^{e2}, R^{e3}, R^{e4}, R^{e1′}, R^{e2′}, R^{e3}, and R^{e4′} are H.

It will also be appreciated that if a mixture of epoxides are used, then each occurrence of R^{e1} and/or R^{e2} (or R^{e3} and/or R^{e4}, R^{e1′} and/or R^{e2′} and R^{e3′} and/or R^{e4′}) may not be the same, for example if a mixture of ethylene oxide and propylene oxide are used in the PC block, R^{e1} (or R^{e3}) may be independently hydrogen or methyl, and R^{e2} (or R^{e4}) may be independently hydrogen or methyl.

The skilled person will understand that when the epoxide is asymmetric, the adjacent epoxide monomer units in the backbone may be head-to-tail linkages, head-to-head linkages, or tail-to-tail linkages.

Preferably, the surface-active agent has a molecular weight (Mn) in the range of from about 300 to 20,000 Da, more preferably in the range of from about 400 to 8000 Da, most preferably from about 500-6000 Da.

The polycarbonate block of the surface-active agent preferably has a molecular weight (Mn) in the range of from about 200 to 4000 Da, more preferably in the range of from about 200 to 2000 Da, most preferably from about 200 to 1000 Da, especially from about 400 to 800 Da.

The polyether block of the surface-active agent preferably has a molecular weight (Mn) in the range of from about 100 to 20,000 Da, more preferably of from about 200 to 10,000 Da, most preferably from about 200 to 5000 Da.

The Mn and hence the PDI of the polymers produced by the processes of the invention may be measured using Gel Permeation Chromatography (GPC). For example, the GPC may be measured using an Agilent 1260 Infinity GPC machine with two Agilent PLgel μ-m mixed-D columns in series. The samples may be measured at room temperature (293K) in THE with a flow rate of 1 mL/min against narrow polystyrene standards (e.g., polystyrene low EasiVials supplied by Agilent Technologies with a range of Mn from 405 to 49,450 g/mol). Optionally, the samples may be measured against poly(ethylene glycol) standards, such as polyethylene glycol EasiVials supplied by Agilent Technologies.

The polycarbonate block of the surface-active agent may have at least 50% carbonate linkages, preferably at least 60% carbonate linkages, preferably at least 70% carbonate linkages, preferably at least 76% carbonate linkages, preferably at least 80% carbonate linkages, more preferably at least 85% carbonate linkages, at least 90% carbonate linkages or at least 95% carbonate linkages.

The polycarbonate block of the surface-active agent may also comprise ether linkages. The polycarbonate block may have less than 50% ether linkages, preferably less than 40% ether linkages, preferably less than 30% ether linkages, preferably less than 24% ether linkages, preferably less than 20% ether linkages, more preferably less than 15% ether linkages, less than 10% ether linkages, less than 5% ether linkages, less than 3% ether linkages or less than 1% ether linkages.

For the avoidance of doubt, where the polycarbonate block comprises ether linkages, the polycarbonate block will not solely comprise P repeat units of formula

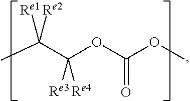

i.e., solely carbonate linkages, but will instead comprise a mixture of both carbonate linkages as shown, and ether linkages as shown for the PE block. P is the sum of carbonate linkages and ether linkages in the PC block. Each carbonate or ether linkage comprises a repeat unit that may be derived from an alkylene oxide moiety, i.e.,

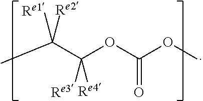

Therefore, where ether linkages are present, P may be considered as the number of repeat alkylene oxide derived moieties in the PC block.

Optionally, the polycarbonate block may be a generally alternating polycarbonate residue. If the epoxide is asymmetric, then the polycarbonate may have between 0-100% head to tail linkages, preferably between 40-100% head to tail linkages, more preferably between 50-100%. The polycarbonate may have a statistical distribution of head to head, tail to tail and head to tail linkages in the order 1:2:1, indicating a non-stereoselective ring opening of the epoxide, or it may preferentially make head to tail linkages in the order of more than 50%, optionally more than 60%, more than 70%, more than 80%, or more than 90%.

Optionally, the polyether block comprises only ether linkages. Typically, the polyether block is at least 90% derived, typically, at least 95% derived, more typically, at least 99%, most typically, 100% derived from epoxides.

Typically, the polyether block has less than 40% carbonate linkages, typically, less than 30% carbonate linkages, typically, less than 20% carbonate linkages, more typically, less than 10% carbonate linkages, most typically less than 5%, less than 2% or less than 1% carbonate linkages. The polyether block may have 0% carbonate linkages.

For the avoidance of doubt, where the polyether block comprises carbonate linkages, the polyether block will not solely comprise Q repeat units of formula

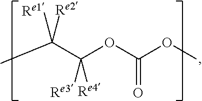

i.e., solely ether linkages, but will instead comprise a mixture of both ether linkages as shown, and carbonate linkages as shown for the PC block. Q is the sum of ether linkages and carbonate linkages in the PE block. Each ether or carbonate linkage comprises a repeat unit that may be derived from an alkylene oxide moiety, i.e.,

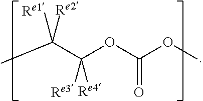

Therefore, where carbonate linkages are present in the PE block, Q may be considered as the number of repeat alkylene oxide derived moieties in the PE block.

Typically, the polycarbonate block is derived from epoxide and CO₂, more typically, epoxide and CO₂ provide at least 70% of the residues in the block, especially, at least 80% of the residues in the block, more especially, at least 90% of the residues in the block, most especially, the polycarbonate block at least 95% of the residues in the block are residues of epoxide and CO₂.

Most typically, the polycarbonate block includes ethylene oxide and/or propylene oxide residues and optionally butylene oxide. At least 30% of the epoxide residues of the polycarbonate block may be ethylene oxide or propylene oxide residues, typically, at least 50% of the epoxide residues of the polycarbonate block are ethylene oxide or propylene oxide residues, more typically, at least 75% of the epoxide residues of the polycarbonate block are ethylene oxide or propylene oxide residues, most typically, at least 90% of the epoxide residues of the polycarbonate block are ethylene oxide or propylene oxide residues.

Typically, the polycarbonate block is derived from CO₂ i.e., the carbonates incorporate CO₂ residues. Typically, the polycarbonate block has between 70-100% carbonate linkages, more typically, 80-100%, most typically, 90-100%.

The value of P in Formula I does not exceed the value of Q. Preferably the ratio of Q to P is at or between 5:1 and 1:1, preferably between 2:1 and 1:1. By having P less than or equal to Q the solubility of the surface-active agent in water is improved. Preferably when the PC blocks derive from ethylene oxide the P:Q ratio is such that the carbonate blocks contribute at least about 50% w/w, preferably at least about 60% w/w of the composition. In this case PC weight contribution is most preferably from about 50% w/w up to about 66-67% w/w of the composition. Preferably when the PC blocks derive from propylene oxide the P:Q ratio is such that the carbonate blocks contribute at least about 25% w/w, preferably at least about 40% w/w, of the composition. In this case the PC weight contribution is most preferably from about 50% w/w up to about 70% w/w of the composition. Controlling the w/w carbonate content permits control over water solubility, renewable carbon content and amphiphilicity, which relates to surface active performance. We find that the more preferred surface-active agents in accordance with the invention comprise 50-70 wt % carbonate blocks, even more preferred is 55-70 wt %.

The value of P is typically between 3 and 100, preferably between 3 and 50, 3 and 20 or 3 and 15. The value of Q is typically between 3 and 200, preferably between 3 and 100, 3 and 50, 5 and 20 or 5 and 15. The value of P may be between 20 and 100. The value of Q may be between 20 and 200.

Z¹ is R, R—O, R—C(O)—O or R—O—C(O)—O. Preferably Z¹ is R—C(O)—O or R—O—C(O)—O. Preferably Z¹ is a short (e.g. C₂-C₅ or C₂-C₄) chain carbonate or ester group.

R is a C₁ to C₁₁ alkyl group. R may be a linear or branched C₁ to C₁₁ alkyl group. Preferably R is a C₂ to C₁₁ alkyl group, more preferably a C₂ to C₆ or a C₂ to C₅ alkyl group, typically a C₂ to C₄ alkyl group. Preferably R is a linear alkyl group, preferably a linear C₂-C₁₁ alkyl group. Preferably R is derived from a C₁ to C₁₁ alcohol, preferably a C₂ to C₆ alcohol, typically a C₂ to C₅ alcohol or a C₂ to C₄ alcohol. Preferably R is derived from a linear C₁ to C₁₁ alcohol, preferably a linear C₂ to C₆ or a C₂ to C₅ alcohol, typically a linear C₂ to C₄ alcohol or a linear C₂ to C₄ alcohol. Preferably the C₁ to C₁ alcohol is derived from renewable feedstocks. For example, the alcohol may be bioethanol etc.

Z² is H, R, R—(O)C or R—O—(O)C, preferably Z² is H or methyl, most preferably, Z² is H.

In certain embodiments R^{e1}, R^{e2}, R^{e3}, and R^{e4} may independently be selected from H, methyl, or 40 ethyl; R^{e1′}, R^{e2′}, R^{e3′}, and R^{e4′} may independently be selected from H, methyl, or ethyl, Z² may be methyl or H and the polyether block may have less than 2% carbonate linkages.

According to a second aspect of the invention there is also provided a process for producing a surface-active agent according to the first aspect of the invention the process comprising the steps of (i) reacting carbon dioxide and an epoxide in the presence of a carbonate catalyst, and a monofunctional starter compound to form a polycarbonate compound and (ii) reaction of the polycarbonate compound of step (i) with an epoxide and an ether catalyst to produce the surface-active agent according to the first aspect of the invention.

The monofunctional starter may be a C₁ to C₁₁ alcohol or a C₁ to C₁₁ carboxylic acid. Typically, the monofunctional starter is a C₁ to C₁₁ alcohol, preferably a C₂ to C₁₁ alcohol, typically a C₂₋₆ alcohol or C₂₋₄ alcohol.

The epoxide is selected from ethylene oxide, propylene oxide, butylene oxide, pentylene oxide, hexylene oxide, glycidyl ethers, glycidyl esters or glycidyl carbonates or a mixture of two or more thereof. Typically, the epoxide is selected from ethylene oxide, propylene oxide or a mixture thereof, preferably ethylene oxide.

The carbonate catalyst may be heterogeneous or homogeneous.

The carbonate catalyst may be a mono-metallic, bimetallic, or multi-metallic homogeneous complex or it may be a non-metallic Lewis acid-base pair (for example based upon combination of boranes and ammonium salts, as disclosed in patents WO2016203408, WO2020121262, WO2021005470).

The carbonate catalyst may comprise phenol or phenolate ligands.

Typically, the carbonate catalyst may be a bimetallic complex comprising phenol or phenolate ligands. The two metals may be the same or different.

The carbonate catalyst may be a catalyst of formula (IV):

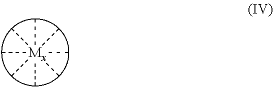

wherein:
M is a metal cation represented by M-(L)ᵥ;
x is an integer from 1 to 4, preferably x is 1 or 2;

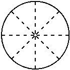

is a multidentate ligand or plurality of multidentate ligands;
L is a coordinating ligand, for example, L may be a neutral ligand, or an anionic ligand that is capable of ring-opening an epoxide;
v is an integer that independently satisfies the valency of each M, and/or the preferred coordination geometry of each M or is such that the complex represented by formula (IV) above has an overall neutral charge. For example, each v may independently be 0, 1, 2 or 3, e.g., v may be 1 or 2. When v>1, each L may be different.

The term multidentate ligand includes bidentate, tridentate, tetradentate and higher dentate ligands. Each multidentate ligand may be a macrocyclic ligand or an open ligand.

Such catalysts include those in WO2010022388 (metal salens and derivatives, metal porphyrins, corroles and derivatives, metal tetraaza annulenes and derivatives), WO2010028362 (metal salens and derivatives, metal porphyrins, corroles and derivatives, metal tetraaza annulenes and derivatives), WO2008136591 (metal salens), WO2011105846 (metal salens), WO2014148825 (metal salens), WO2013012895 (metal salens), EP2258745A1 (metal porphyrins and derivatives), JP2008081518A (metal porphyrins and derivatives), CN101412809 (metal salens and derivatives), WO2019126221 (metal aminotriphenol complexes), U.S. Pat. No. 9,018,318 (metal beta-diiminate complexes), U.S. Pat. No. 6,133,402A (metal beta-diiminate complexes) and U.S. Pat. No. 8,278,239 (metal salens and derivatives), the entire contents of which, especially, insofar as they relate to suitable carbonate catalysts for the reaction of CO₂ and epoxide, in the presence of a starter and optionally a solvent as defined herein are incorporated herein by reference.

Preferably the carbonate catalysts are bimetallic phenolate catalysts. Suitable bimetallic phenolate complexes are those described in WO2009/130470, WO2013/034750, WO2016/012786, WO2016/012785, WO2012037282 and WO2019048878A1, the entire contents of which, especially, insofar as they relate to suitable carbonate catalysts for the reaction of CO₂ and epoxide, in the presence of a starter and optionally a solvent as defined herein are incorporated herein by reference.

The ether catalyst may be any catalyst suitable for polymerising epoxides to form polyethers. Suitable ether catalysts include DMC catalysts, metal alkoxides, boron-based catalysts such as BF₃ or BH₃, anionic catalysts such as KOH, cationic, acidic or superacidic catalysts (such as HSbF₆, CF₃SO₃H), PFs, activated monomer catalysts, organic catalysts such as imidazole or phosphazene reagents and metallosalenate catalysts. Preferably the ether catalyst is a DMC catalyst. Examples of DMC catalysts which can be used in the process of the invention include those described in U.S. Pat. Nos. 3,427,256, 5,536,883, 6,291,388, 6,486,361, 6,608,231, 7,008,900, 5,482,908, 5,780,584, 5,783,513, 5,158,922, 5,693,584, 7,811,958, 6,835,687, 6,699,961, 6,716,788, 6,977,236, 7,968,754, 7,034,103, 4,826,953, 4,500,704, 7,977,501, 9,315,622, EP-A-1568414, EP-A-1529566, and WO 2015/022290, the entire contents of which are incorporated by reference.

The ratio of the carbonate catalyst to the ether catalyst may be in the range of from about 300:1 to about 1:100, for example, from about 120:1 to about 1:75, such as from about 40:1 to about 1:50, e.g. from about 30:1 to about 1:30 such as from about 20:1 to about 1:1, for example from about 10:1 to about 2:1, e.g. from about 5:1 to about 1:5. These ratios are mass ratios.

The process may be carried out in a one pot reactor or may be a dual reactor process.

Hence, according to a third aspect of the invention there is also provided a process for producing a surface-active agent according to the first aspect of the invention in a multiple reactor system; the system comprising a first and second reactor wherein a first reaction takes place in the first reactor and a second reaction takes place in the second reactor; wherein the first reaction is the reaction of a carbonate catalyst with CO₂ and epoxide, in the presence of a monofunctional starter compound, and optionally a solvent, to produce a polycarbonate compound and the second reaction is the semi-batch or continuous reaction of an ether catalyst with the polycarbonate compound of the first reaction and epoxide to produce the surface-active agent according to the first aspect of the invention.

Typically, the reaction mixture from the first step contains less than 5% CO₂ by weight of the reaction mixture prior to the second step, preferably less than 2.5%, such as less than 1.0%, less than 0.5% or less than 0.1%. Typically, the second step is carried out without the independent addition of CO₂, however it can be carried out under a pressure of CO₂. The polyether block produced in the second step may have less than 40% carbonate linkages, preferably less than 30% carbonate linkages or less than 20% carbonate linkages, more preferably less than 10%, less than 5%, less than 2% or less than 1% carbonate linkages. Preferably the polyether block produced in the second step is substantially free from carbonate linkages.

Typically, therefore the second step is carried out substantially in the absence of CO₂.

Accordingly, by substantially in the absence of CO₂ is meant that the second step is carried out in the presence of less than 4% CO₂ by weight, preferably less than 2%, such as less than 1.0%, less than 0.5% or less than 0.1% by weight of total reactants, catalyst, and products in the second step.

Adding the components in the separate steps may be useful to increase activity of the catalysts and may lead to a more efficient process, compared with a process in which all of the materials are provided at the start of the process. Large amounts of some of the components present throughout the process may reduce efficiency of the catalysts. Reacting this material in separate steps may prevent this reduced efficiency of the catalysts and/or may optimise catalyst activity. The reaction conditions of each step can be tailored to optimise the reactions for each catalyst.

The ether catalyst may be pre-activated prior to addition in the second step. Such pre-activation may be achieved by mixing one or both catalysts with epoxide (and optionally other components). Pre-activation of the ether catalyst is useful as it enables safe control of the reaction (preventing uncontrolled increase of unreacted monomer content) and removes unpredictable activation periods.

Although typically any residual CO₂ from the first step may be removed from the crude reaction product of the first step prior to commencement of the second step such that the second step is carried out without CO₂, it will be appreciated that a small amount of CO₂ may be present in the reaction mixture in the second step as an unused reagent of the first step. Alternatively, both steps may be carried out under a pressure of CO₂.

The reactions of the present invention may be carried out in the presence of a solvent; however, it will also be appreciated that the processes may also be carried out in the absence of a solvent. When a solvent is present, it may be toluene, hexane, t-butyl acetate, diethyl carbonate, dimethyl carbonate, dioxane, dichlorobenzene, methylene chloride, propylene carbonate, ethylene carbonate, acetone, ethyl acetate, propyl acetate, n-butyl acetate, tetrahydrofuran (THF), etc. The solvent may be toluene, hexane, acetone, ethyl acetate and n-butyl acetate.

Adding the components in the separate reactions and reactors may be useful to increase activity of the catalysts and may lead to a more efficient process, compared with a process in which all of the materials are provided at the start of one reaction. Large amounts of some of the components present throughout the reaction may reduce efficiency of the catalysts. Reacting this material in separate reactors may prevent this reduced efficiency of the catalysts and/or may optimise catalyst activity. The reaction conditions of each reactor can be tailored to optimise the reactions for each catalyst.

Additionally, not loading the total amount of each component at the start of the reaction and having the catalyst for the first reaction in a separate reactor to the catalyst for the second reaction, may lead to even catalysis, and more uniform polymer products. This in turn may lead to polymers having a narrower molecular weight distribution, desired ratio, and distribution along the chain of ether to carbonate linkages, and/or improved stability.

Having the reactions with the two different catalysts separate and mixing only certain components in the first reaction and adding the remainder in the second reaction may also be useful, for example by adding a pre-activated ether catalyst or adding the reaction mixture to a pre-activated ether catalyst.

Preferred ether catalysts and carbonate catalysts are as for the second aspect of the invention.

The first reaction may be carried out in more than one reactor that feeds the crude reaction mixture into the second reaction, and reactor, continuously. Preferably, the second reaction is run in a continuous mode.

The product of the first reaction may be stored for subsequent later use in the second reactor.

The two reactors may be located in a series, or the reactors may be nested. Each reactor may individually be a stirred tank reactor, a loop reactor, a tube reactor, or other standard reactor design.

Alternatively, the surface-active agent of the first aspect may be formed by reacting a monofunctional polyether starter compound with an epoxide and carbon dioxide in the presence of a carbonate catalyst. Hence, according to a further aspect of the invention is provided a method of producing a surface-active agent according to the first aspect of the invention, wherein a mono-hydroxy functional polyether is reacted (i) with a carbonate catalyst, epoxide and CO₂ and (ii) with an end-capping group, such as an anhydride, to produce the surface-active agent of the invention.

Typically, the resulting polycarbonate block is end capped with any suitable functional group. End capping the polycarbonate block stabilises the surface-active agent. Typically, the polycarbonate block is end capped with a suitable anhydride, typically an alkyl anhydride. The monofunctional polyether starter compound may be any suitable monofunctional polyether starter compound, typically a monofunctional PEG compound.

### Definitions

The term “alkyl,” as used herein, unless otherwise defined refers to saturated, linear- or branched-chain hydrocarbon radicals derived by removal of a single hydrogen atom from an aliphatic moiety. An alkyl group may be a “C₁₋₂₀ alkyl group”, that is an alkyl group that is a straight or branched chain with 1 to 20 carbons. The alkyl group therefore has 1, 2, 3, 4, 5, 6, 7, 8, 9, 10, 11, 12, 13, 14, 15, 16, 17, 18, 19 or 20 carbon atoms. Preferably, an alkyl group is a C₁₋₁₅ alkyl, preferably a C₁₋₁₂ alkyl, more preferably a C₁₋₁₀ alkyl, even more preferably a C₁₋₈ alkyl, even more preferably a C₁₋₆ alkyl group.

Unless defined otherwise herein, an ester group is optionally —OC(O)R¹— or —C(O)OR¹— wherein R¹ can be an aliphatic, heteroaliphatic, alicyclic, heteroalicyclic, aryl or heteroaryl group. R¹ may be unsubstituted aliphatic, alicyclic or aryl. Optionally R¹ is methyl, ethyl, propyl, or phenyl. The ester group may be terminated by an aliphatic, heteroaliphatic, alicyclic, heteroalicyclic, aryl or heteroaryl group. It will be appreciated that if R¹ is hydrogen, then the group defined by —OC(O)R¹— or —C(O)OR¹— will be a carboxylic acid group.

A carbonate group is optionally —OC(O)OR², wherein R² can be hydrogen, an aliphatic, heteroaliphatic, alicyclic, heteroalicyclic, aryl or heteroaryl group. R² may be optionally substituted aliphatic, alicyclic or aryl. Optionally R² is hydrogen, methyl, ethyl, propyl, butyl (for example n-butyl, isobutyl, or tert-butyl), phenyl, pentafluorophenyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, trifluoromethyl, cyclohexyl, benzyl or adamantyl. Optionally R² is methyl, ethyl, propyl, or phenyl. It will be appreciated that if R² is hydrogen, then the group defined by —OC(O)OR² will be a carbonic acid group.

A carbonate functional group is —OC(O)O— and may be derived from a suitable source. Generally, it is derived from CO₂.

An ether group is optionally —OR³ wherein R³ can be an aliphatic, heteroaliphatic, alicyclic, heteroalicyclic, aryl or heteroaryl group. R³ may be unsubstituted aliphatic, alicyclic or aryl. Optionally R³ is methyl, ethyl, propyl, butyl (for example n-butyl, isobutyl, or tert-butyl), phenyl, pentafluorophenyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, trifluoromethyl or adamantyl. Optionally R³ is methyl, ethyl, propyl, or phenyl.

As used herein, the term “optionally substituted” means that one or more of the hydrogen atoms in the optionally substituted moiety is replaced by a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position. Combinations of substituents envisioned by this invention are preferably those that result in the formation of stable compounds. The term “stable”, as used herein, refers to compounds that are chemically feasible and can exist for long enough at room temperature i.e. (16-25° C.) to allow for their detection, isolation and/or use in chemical synthesis.

Substituents may be depicted as attached to a bond that crosses a bond in a ring of the depicted molecule. This convention indicates that one or more of the substituents may be attached to the ring at any available position (usually in place of a hydrogen atom of the structure). In cases where an atom of a ring has two substitutable positions, two groups (either the same or different) may be present on that atom.

Preferred optional substituents for use in the present invention include, but are not limited to, halogen, hydroxy, nitro, carboxylate, carbonate, alkoxy, aryloxy, alkylthio, arylthio, heteroaryloxy, alkylaryl, amino, amido, imine, nitrile, silyl, silyl ether, ester, sulfoxide, sulfonyl, acetylide, phosphinate, sulfonate or optionally substituted aliphatic, heteroaliphatic, alicyclic, heteroalicyclic, aryl or heteroaryl groups (for example, optionally substituted by halogen, hydroxy, nitro, carbonate, alkoxy, aryloxy, alkylthio, arylthio, amino, imine, nitrile, silyl, sulfoxide, sulfonyl, phosphinate, sulfonate or acetylide).

Particularly preferred optional substituents for use in the present invention are selected from nitro, C₁₋₁₂ alkoxy (e.g., OMe, OEt, OⁱPr, OⁿBu, O^{t}Bu), C₆₋₁₈ aryl, C₂₋₁₄ heteroaryl, C₂₋₁₄ heteroalicyclic, C₁₋₆ alkyl, C₁₋₆ haloalkyl, F, Cl, Br, I and OH, wherein in each of said C₁₋₁₂ alkoxy, C₆₋₁₈ aryl, C₂₋₁₄ heteroaryl, C₂₋₁₄ heteroalicyclic, C₁₋₆ alkyl and C₁₋₆ haloalkyl group may be optionally substituted by an optional substituent as defined herein.

The term “continuous” used herein can be defined as the mode of addition of materials or may refer to the nature of the reaction method as a whole.

In terms of continuous mode of addition, the relevant materials are continually or constantly added during the course of a reaction. This may be achieved by, for example, adding a stream of material with either a constant flow rate or with a variable flow rate. In other words, the one or more materials are added in an essentially non-stop fashion. It is noted, however, that non-stop addition of the materials may need to be briefly interrupted for practical considerations, for example to refill or replace a container of the materials from which these materials are being added.

In terms of a whole reaction being continuous, the reaction may be conducted over a long period of time, such as a number of days, weeks, months, etc. In such a continuous reaction, reaction materials may be continually topped-up and/or products of the reaction may be tapped-off. It will be appreciated that although catalysts may not be consumed during a reaction, catalysts may in any case require topping-up, since tapping-off may deplete the amount of catalyst present.

A continuous reaction may employ continuous addition of materials.

A continuous reaction may employ a discontinuous (i.e., batch-wise or semi batch-wise) addition of materials

The term series used herein refers to when two or more reactors are connected so that the crude reaction mixture can flow from the first reactor to the second reactor.

The term nested used herein refers to when two or more reactors are configured so that one is located within the other. For example, in the present invention, when the second reactor is located inside the first reactor, allowing the conditions of both reactors to influence the other.

### EXAMPLES

### General Example 1—Carbonate Block Formation onto a Monofunctional Polyether

Catalyst (1) was prepared according to Example 2 of WO2017/037441. Polyethylene glycol monomethyl ether was added to a 100 mL Parr high pressure reactor. The vessel was dried by heating to 100° C. under vacuum for 60 mins before cooling and filling with low pressure C₀₂. Catalyst (1) was added.

To the mixture was added epoxide. The mixture was stirred and pressurized to approximately half target-pressure. The mixture was then heated to target temperature (70° C.) and pressure (20 bar) held at constant temperature.

At the end of the desired reaction time, the mixture was cooled to <10° C. and vented through an acid scrubber system.

The mono-ol was dissolved in dichloromethane containing triethylamine (1.3 eq.) and alkyl anhydride (1.05 eq.) and reacted at reflux for 16 h. The end-capped mono-ol was washed with water and brine, dried over sodium sulfate, and concentrated to dryness in vacuo to afford the desired product. Ethylene carbonate by-product was removed using a Kugelrohr or short path evaporator (SPE).

TABLE 1
Example 1 experimental conditions

| | | | Starter | | | | | | |
|---|---|---|---|---|---|---|---|---|---|
| Entry | Cat/g | Starter/Mn | mass/g | Epoxide | Epoxide/mL | TEA/mL | DCM/mL | Anhydride | Anhydride/mL |
| 1 | 0.27 | 350 | 7.5 | PO | 20 | 3.9 | 30 | Propionic | 2.9 |
| 2 | 0.37 | 350 | 10.5 | EO | 20 | 5.5 | 40 | Propionic | 4.0 |
| 3 | 0.53 | 550 | 23.6 | PO | 20 | 7.7 | 60 | Propionic | 5.2 |
| 4 | 0.27 | 550 | 11.8 | PO | 20 | 3.9 | 30 | Propionic | 2.9 |
| 5 | 0.18 | 550 | 11.8 | PO | 20 | 3.9 | 30 | Hexanoic | 5.2 |
| 6 | 0.27 | 550 | 15.7 | EO | 20 | 5.2 | 40 | Propionic | 3.8 |
| 7 | 0.35 | 550 | 14.7 | EO | 30 | 4.8 | 40 | Propionic | 3.6 |
| 8 | 0.33 | 550 | 15.1 | EO | EO: 10 | 5.4 | 40 | Propionic | 4.0 |
| | | | | PO | PO: 14 | | | | |
| 9 | 0.37 | 165 | 5.9 | PO | 20 | 6.5 | 50 | Propionic | 4.8 |
| 10 | 0.21 | 550 | 9.4 | EO | 30 | 3.1 | 25 | Propionic | 2.3 |

TABLE 2
Example 1 results

| | Mn | PDI | CO₂ | Carbonate | | | Water soluble |
|---|---|---|---|---|---|---|---|
| Entry | (GPC) | (GPC) | wt % | wt % | p | q | @ 0.25 g/mL |
| 1 | 1900 | 1.12 | 32 | 78 | 14 | 7 | N (not soluble |
| | | | | | | | at 0.1 g/mL) |
| 2 | 1000 | 1.15 | 26 | 57 | 6 | 7 | Y |
| 3 | 1000 | 1.13 | 13 | 33 | 3 | 12 | Y |
| 4 | 1600 | 1.19 | 24 | 60 | 9 | 12 | Y |
| 5 | 1700 | 1.10 | 24 | 58 | 9 | 12 | Y |
| 6 | 1500 | 1.13 | 26 | 56 | 9 | 12 | Y |
| 7 | 1800 | 1.17 | 30 | 63 | 12 | 12 | Y |
| 8 | 1560 | 1.13 | 24 | 52 | 7 | 12 | Y |
| 9 | 700 | 1.15 | 25 | 65 | 4 | 3 | N (not soluble |
| | | | | | | | at 0.1 g/mL) |
| 10 | 2700 | 1.07 | 36 | 76 | 22 | 12 | N (not soluble |
| | | | | | | | at 0.1 g/mL) |

The data shows that polycarbonate block polyether surface-active agents of the invention are soluble in water, and that water solubility may be preferentially facilitated with respect to wt % carbonate content; preferential ranges of wt % carbonate content being described above.

### General Example 2

### Reaction 1

Mono-ol starter was added to a 100 mL Parr high pressure reactor system. The vessel was dried by heating to 100° C. under vacuum for 60 mins before cooling and filling with low pressure CO₂. Catalyst (1) (see example 1) was added.

To the mixture was added EO. The mixture was stirred and pressurized to approximately half target-pressure. The mixture was then heated to target temperature and pressure held at constant temperature and target pressure.

At the end of the desired reaction time, the mixture was cooled to <10° C. and vented through an acid scrubber system. EO and anhydrous ethyl acetate were added to the cold stirring mixture before transferring into an intermediate holding vessel.

### Reaction 2:

Pre-dried mono-ol starter and a DMC composed of zinc hexacyanocobaltate and tert-butyl alcohol (2) was added to a 100 mL Parr high pressure reactor system. The vessel was held under vacuum for approximately 2 mins before filling with low pressure N2 and then anhydrous ethyl acetate (15 mL).

This vessel was then heated with 130° C. with stirring and the DMC activated with 2 portions of approximately 0.3 g PO. After activation (as evidenced by pressure drops) the external heater was removed, optionally the reactor could be pressurized with C₀₂, then the mixture was cooled to the target addition temperature.

Upon reaching the target temperature, the mixture from Reaction 1 was added onto the active DMC system over approximately 60-90 mins. Once addition of the mixture was complete, the mixture was left to “cook-out” for several hours before cooling, venting and taking samples for analysis by NMR and GPC.

TABLE 3
Example 2 Reaction 1 experimental conditions/results

| | | | | | | | | Top-up | | |
|---|---|---|---|---|---|---|---|---|---|---|
| | Cat | | Starter | | | Pressure/ | Top-up | EtOAc/ | Mn | PDI |
| Entry | 1/g | Starter | mass/g | EO/mL | Temp/° C. | barg | EO/mL | mL | (GPC) | (GPC) |
| 11 | 0.28 | EtOH | 1.1 | 30 | 75 | 20 | 20 | 10 | 1400 | 1.09 |

TABLE 4
Example 2 Reaction 2 experimental conditions

| | | | | Feed | | Reactor |
|---|---|---|---|---|---|---|
| | DMC/ | | Starter | temper- | Reactor | Pressure/ |
| Entry | mg | Starter | mass/g | ature/° C. | gas | barg |
| 11 | 15 | 1-Dodecanol | 0.85 | 85 | N₂ | N/A |

TABLE 5
Example 2 Reaction 2 results

| | Mn | PDI | CO₂ | | | Water |
|---|---|---|---|---|---|---|
| Entry | (GPC) | (GPC) | wt % | p | q | solubility |
| 11 | 1800 | 1.23 | 28.8 | 13 | 9 | N (not soluble |
| | | | | | | at 0.1 g/mL) |

1. A surface-active agent comprising a polycarbonate block polyether of the formula I
Z¹—(PC)_{P}—(PE)_{Q}-Z² (I)
wherein PC represents a carbonate block with P repeat units of formula 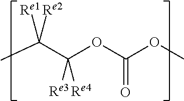
wherein R^{e1}, R^{e2}, R^{e3}, and R^{e4} are independently selected from H, methyl, ethyl, propyl, butyl, or an ether, ester or carbonate group, with the proviso that when one of R^{e1}, R^{e2}, R^{e3}, and R^{e4} is methyl, ethyl, propyl, butyl, or an ether, ester or carbonate group, the remaining R^{e1}, R^{e2}, R^{e3}, and R^{e4} are H;
PE represents a polyether block with Q repeat units of formula 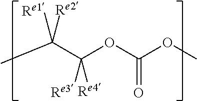
wherein R^{e1′}, R^{e2′}, R^{e3′}, and R^{e4′} are independently selected from H, methyl, ethyl, propyl, butyl, or an ether, ester or carbonate groups, with the proviso that when one of R^{e1}, R^{e2}, R^{e3}, and R^{e4} is methyl, ethyl, propyl, butyl, or an ether, ester or carbonate group, the remaining R^{e1′}, R^{e2′}, R^{e3′}, and R^{e4′} are H;
Z¹ is R, R—O, R—C(O)—O— or R—O—C(O)—O;
R is an optionally substituted straight or branched chain C₁-C₁₁ alkyl group;
Z² is H, R, R—(O)C or R—O—(O)C; and
wherein the value of P does not exceed the value of Q.

2. The surface-active agent according to claim 1, wherein R is a C₂-C₁₁ alkyl group.

3. The surface-active agent according to claim 1, wherein R is a linear alkyl group.

4. The surface-active agent according to claim 1, wherein R is a C₂-C₆ alkyl group, typically a C₂-C₅ alkyl group or a C₂-C₄ alkyl group.

5. The surface-active agent according to claim 2, wherein R^{e1}, R^{e2}, R^{e3}, R^{e4} R^{e1′}, R^{e2′}, R^{e3′}, and R^{e4′} are independently selected from H, methyl, or ethyl.

6. The surface-active agent according to claim 1, wherein Z¹ is R—C(O)—O or R—O—C(O)—O.

7. The surface-active agent according to claim 1, wherein Z² is H or methyl.

8. The surface-active agent according to claim 1, wherein the total surface-active agent has greater than 10 wt % CO₂ incorporation.

9. The surface-active agent according to claim 1, wherein the total surface-active agent has 10 to 40 wt % CO₂ incorporation.

10. The surface-active agent according to claim 1, wherein the Q:P ratio is at or between 1:1 and 5:1.

11. The surface-active agent according to claim 1, wherein P is at or between 3 and 100.

12. The surface-active agent according to claim 1, wherein Q is at or between 3 and 200.

13. The surface-active agent according to claim 1, wherein the polyether block has less than 40% carbonate linkages.

14. The surface-active agent according to claim 1 wherein the polyether block has 0% carbonate linkages.

15. The surface-active agent according to claim 1 which is water-soluble.

16. The surface-active agent according to claim 15 having water solubility of at least about 0.25 g/ml at STP.

17. The surface-active agent according to claim 1, wherein the P:Q ratio is such that the carbonate blocks contribute at least about 50% w/w.

18. The surface-active agent according to claim 1, wherein the P:Q ratio is such that the carbonate blocks contribute from about 50% w/w to about 70% w/w of the surface-active agent.

19. A method of producing a surface-active agent according to claim 1, wherein the method comprises the steps of:
(i) reacting carbon dioxide and an epoxide in the presence of a carbonate catalyst, and a monofunctional starter compound to form a polycarbonate compound and
(ii) reacting of the polycarbonate compound of step (i) with an epoxide and an ether catalyst to produce the surface-active agent according to claim 1.

20. A method of producing a surface-active agent according to claim 1, in a multiple reactor system; the system comprising a first and second reactor wherein a first reaction takes place in the first reactor and a second reaction takes place in the second reactor; wherein the first reaction is the reaction of a carbonate catalyst with CO₂ and epoxide, in the presence of a monofunctional starter compound, and optionally a solvent, to produce a polycarbonate compound and the second reaction is the semi-batch or continuous reaction of an ether catalyst with the polycarbonate compound of the first reaction and epoxide to produce the surface-active agent according to claim 1.

21. The method of claim 18, wherein the carbonate catalyst is a bimetallic phenolate complex.

22. The method of claim 18, wherein the ether catalyst is a DMC catalyst.

23. A method of producing a surface-active agent according to claim 1, wherein a mono-hydroxy functional polyether is reacted
(iii) with a carbonate catalyst, epoxide and CO₂ and
(ii) with an end-capping group, such as an anhydride, to produce the surface-active agent of claim 1.

24. (canceled)
